(19) United States
(12) Patent Application Publication
(10) Pub. No.: US 2007/0156779 A1
(43) Pub. Date: Jul. 5, 2007

(54) Synchronizing Media Within A Portable Device

(75) Inventors: Choe Sung Ho, Yongsan-gu (KR); Kang Seong Cheol, Osan-shi (KR)

Correspondence Address: FISH & RICHARDSON P.C., P.O. BOX 1022, MINNEAPOLIS, MN, 55440-1022, US

(73) Assignee: LG Electronics Inc., Youngdungpo-su (KR)

(21) Appl. No.: 11/561,177

(22) Filed: Nov. 17, 2006

(30) Foreign Application Priority Data
Nov. 21, 2005 (KR) 10-2005-0111454

(51) Int. Cl. G06F 12/00; G06F 17/30

(52) U.S. Cl. 707/201

(57) ABSTRACT

Media in a computer system is synchronized with media stored within or transferred to an external computing device, such as a portable media playback device. An operative connection between the external computing device and the computer system is detected by the computer system. A media file in the computer system to be transmitted to the external computing device is selected and a storage path of the selected media file is checked. A parallel storage path is generated in the external computing device by the computer system, and the selected media file is copied and transmitted to the parallel storage path of the external computing device.

### BACKGROUND

This description relates to synchronizing search paths for media files stored within a portable device.

Computer software contents and multimedia data, such as audio and video data, may be compressed in various formats, such as JPEG, MPEG and DVD, and may be stored digitally on various digital media. Data compression and memory technology enable more media data to be stored in a relatively limited memory area. Many types of multimedia playback devices are used to read and play the data stored in the digital media. For example, a DVD player is used to play the compressed audio and video data stored in a DVD media, and a MPEG-3 player or MPEG-3 CD player is used to play data stored using MPEG-3 compression technology.

Video, audio, and image data may be downloaded through the Internet or various media and stored using various compression schemes. A home or office computer system may be capable of managing many multimedia devices and supporting various multimedia formats, but these systems may be limited by the required amount of memory and physical space necessary for a system that can effectively manage large quantities of multimedia data, multimedia formats, and/or multimedia devices.

Portable computing devices that support playback of at least one kind of media format, such as MPEG, MP3, AVI, WAV, JPEG, JPG, or similar are often provided as peripheral devices that may be connected to the home or office computing system. In addition, the memory capacity of portable computing or playback devices is increasing, thereby facilitating the storage and playback of higher-capacity and larger numbers of files. However, as the number of files stored in any portable device increases, the searching and management of multimedia files may become cumbersome and inefficient.

### SUMMARY

In one general aspect, media synchronization for a portable device enables the synchronizing and efficient management of search paths and/or directories of media files stored in a portable device.

In another general aspect, synchronizing media in a computer system with an external computing device includes detecting an operative connection between the external computing device and the computer system. A media file in the computer system is selected to be transmitted to the external computing device. A storage path of the selected media file is checked and a parallel storage path is generated in the external computing device. The selected media file is copied and transmitted to the parallel storage path of the external computing device.

Implementations may include one or more of the following features. For example, a library of media files may be established and the library containing at least the selected media file may be transmitted to the external computing device.

The parallel storage path in the external computing device may include at least one hierarchal file folder.

The external computing device may provide the storage path of the media file. The media storage path in the external computing device may be a folder search path.

A hierarchal folder search and a library search option may be provided for the selected media file of the external device. The transmitting of the selected media file to the parallel storage path of the external computing device may include creating at least one hierarchal folder corresponding to the media storage path.

The media file may include one or more of a still image file, a moving image file, or an audio file. The external computing devices may be a portable media player.

In another general aspect, synchronizing media in a computer system with a portable media playback device includes operatively connecting the portable media playback device to the computer system. A library of media files within the computer system is searched and a media file in the computer system is selected for playback or storage on the portable media playback device. A storage path of the selected media file is identified within the computer system and a parallel storage path is generated in the portable media playback device. The parallel storage path is similar to a storage path of the selected media file within the computer system. The selected media file is transmitted to the parallel storage path of the portable media playback device. The file name of the selected media file and parallel storage path include common characteristics capable of being indexed and searched across both the portable media playback device and the computer system.

In another general aspect, a media synchronization apparatus for a computer system includes a network interface configured to operatively connect to an external device and to transfer media files between the computer system and the external device. The apparatus includes a media storage directory extraction component configured to recognize if the external device is operatively connected to the computer system and to extract a storage path of a selected media file from the computer system, and a controller. The controller is configured to copy and to transmit the extracted storage path of the selected media file to the external device through the network interface. The controller is configured to transmit the extracted storage path and the selected media file to the external device.

Implementations may include one or more of the following features. For example, a data storage device may be configured to generate a library of indexed and searchable media files within the computer system.

The media storage directory extraction component may be configured to extract at least one hierarchal folder path stored in the computer system.

The controller may be configured to generate a parallel storage path of the media file in the external device substantially similar to the storage path in the computer system.

The external device may be a portable media playback device. The portable media playback device can be one or more of a personal digital assistant (PDA), a portable media player (PMP), or an MP3 player.

The parallel storage path generated in the external device may be provided in a search folder directory.

A user interface can be provided for selecting one or more media files to be transmitted to the external device.

In another general aspect, a system for synchronizing media between a portable media playback device and a host computer includes a media file manager within the host computer. The media file manager includes a network interface configured to operatively connect to the portable media playback device and to transfer media files between the host computer and the portable media playback device. A media storage directory extraction component is configured to recognize if the portable media playback device is operatively connected to the host computer and to extract a storage path of a selected media file from the host system. A controller is configured to copy and to transmit the extracted storage path of the selected media file to the portable media playback device through the network interface. The controller is configured to transmit the extracted storage path and the selected media file to the portable media playback device.

Implementations may include one or more of the following features. For example, the system may include the portable media playback device.

The portable media playback device may include a data storage device configured to store one or more media files in a master-slave association with media files stored within the host computer, a controller configured to control a media player for playing or recording a selected media file, and a network interface configured to operatively connect the portable media playback device to the host computer and to transfer media files to and from the host computer.

The portable media playback device may include a user interface configured to enable a user to search media files stored within the data storage device of the portable media playback device or the host computer.

Other features will be apparent from the following description, including the drawings, and the claims.

### BRIEF DESCRIPTION OF THE DRAWINGS

FIG. 1 is a block diagram of a portable device having a media file search path synchronized with a computer system through a network interface.

FIG. 2 is a schematic view of an exemplary process for synchronizing a media path between a data storage component and a network interface.

FIGS. 3A-3B are block diagrams of an exemplary media library and folder path in a media player of a portable device.

FIG. 4 is a flowchart of an exemplary media synchronization process for a portable device.

FIG. 5 is a flowchart of an exemplary media synchronization process for a portable device.

FIG. 6 is a flowchart of an exemplary process for selecting and playing media of a portable device.

### DETAILED DESCRIPTION

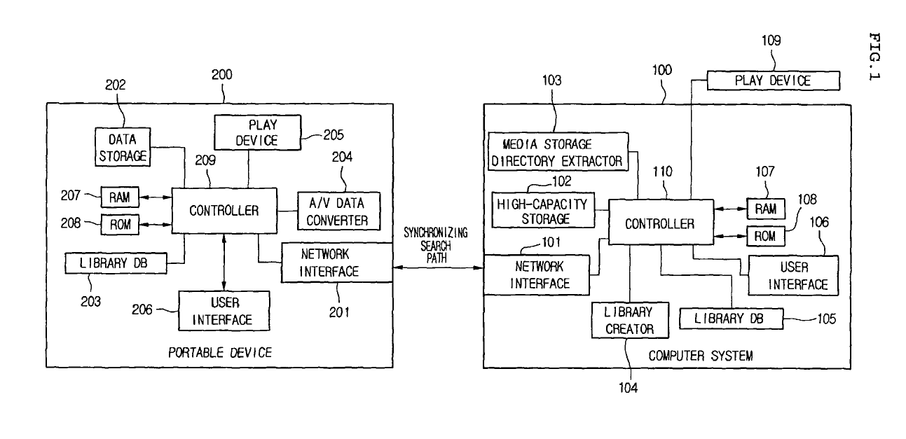

Referring to FIG. 1, a portable device 200 is operatively connected to a computer system 100 through a network interface 201 of device 200 and a network interface 101 of computer system 100. The portable device 200 includes a terminal, such as a personal digital assistant (PDA), a mobile phone, a portable multimedia player (PMP), a MP3 player, or a composite terminal. A composite terminal may include one or more of a broadcasting receiving and playback function, camera capability, multimedia playback and storage, and/or multimedia recording.

The computer system 100 includes the network interface 101 for connection with an external device, such as portable device 200, a high-capacity storage component 102 for storing user's media files and various application files, a media storage path extraction component 103 for extracting storage paths or storage directories of the media files, and a library creation component 104 for creating libraries of the stored media files. The system 100 also includes a library database (DB) 105 for storing the created libraries of the media files, a user interface 106 for controlling the system and external device, a RAM 107 and a ROM 108, a play device 109 for outputting various data, and a controller 110 for controlling and managing the components and devices of the system 100.

The portable device 200 includes the network interface 201 for connection with an external device or system, such as the computer system 100, a data storage component 202 storing data, such as media files, a library database 203 storing libraries of the stored media files, and an A/V (audio/video) data converter 204 for converting input and output A/V data. The portable device 200 also includes a play device 205 for playing A/V data, a user interface 206 for controlling the portable device 200 and playback of content, a ROM 207 and a ROM 208, and a controller 209 for controlling and managing the respective components and devices of the portable device 200.

The computer system 100 may include a notebook computer or a desktop computer. The computer system 100 can store media files (e.g., broadcast programs) that are typically stored or played through other devices (e.g., a TV). For example, the computer system 100 may include a personal video recorder (PVR) or digital video recorder (DVR) that serves as a digital video storage system. The computer system 100 may include a system that stores and plays recorded broadcasting data or programs stored in hard disk drives (HDD) inside the system. An exemplary computer system 100 includes the network interface 101, the high-capacity storage 102, the media storage path extraction component 103, the library creation component 104, the library database 105, the user interface 106, the RAM 107 and the ROM 108, the playback device 109, and the controller 110, and may support storage, playback and/or recording of one or more types of multimedia.

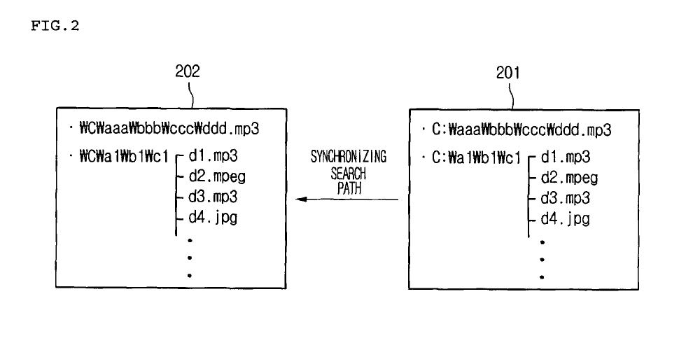

The network interface 101 transmits and receives data through a cable or a wireless network and may include one or more of a USB connection, a serial input/output (SIO), a parallel input/output (PIO), an input/output port (I/O), an RF communication module, and/or a Bluetooth communication module. In the illustrated example of FIGS. 1-2, the network interface 101 is connected to the portable device 200 through a USB port to a cable network.

The high-capacity storage component 102 may include a HDD and stores various media (audio/video), data and operating programs collected by the user. In addition, the computer system 100 can include media recording and playback devices, such as a CD player, a DVD player, a BD (blue laser disk) player, or another similar media player and driver. The RAM 107 provides the main data storage component and the ROM 108 is a semiconductor storage component.

The media storage path extraction component 103 extracts a storage path or storage directory of the computer system with respect to a file copied to the portable device 200 or a file selected by the user. The media storage path extraction component 103 extracts data from a HDD and the lower hierarchy of the files and directory. The media files may include one or more audio or video files, such as MP3, still image and/or movie files.

The library creation component 104 creates libraries of the media files used inside the computer system, and/or libraries of media files copied to the portable device 200. The library database 105 stores the generated libraries of the media files. These libraries are used to classify the media files based on various criteria, such as according to album, genre, musician, and/or composer, and to establish a database of the media files. The library database 105 provides classified applications according to media file play format or type.

The user interface 106 includes a mouse and/or a keyboard, and may further include a remote controller or touch pad. The system operation can be controlled through the user interface 106. The user interface 106 controls media file transmission or deletion to or from the external device, and controls the user selection and playback of files that may be used by or deleted from the external device. The playback device 109 is an audio and video playback device that includes a speaker and a display device.

In response to the connection of an external device, the controller 110 recognizes if a corresponding application is capable of being played by the external device, and therefore also controls the media storage path extraction and the generation of the library database.

The portable device 200 provides playback of various multimedia files, and may be a portable multimedia device, such as a PDA, a PMP, an MP3 player, a broadcasting receiver, or another similar device. The portable device 200 may further include a digital multimedia broadcasting module (e.g., a DMB module) and/or a mobile communication module (e.g., a CDMA module) for digital multimedia broadcasting reception and/or portable telephone capability.

The portable device 200 includes the network interface 201, the data storage component 202, the library database 203, the A/V data converter 204, the play device 205, the user interface 206, the RAM 207 and the ROM 208, and the controller 209.

The network interface 201 is a cable or wireless network connection that can download data via wireless or can download data by connecting to the computer system via a cable connection. The data storage component 202 stores the downloaded, recorded or generated (such as photo or movie files from a camera) media. The operating system or sequences of the portable device 200 can be contained in the RAM 207 and/or the ROM 208. The data storage component 202 may include a memory integral to the portable device 200, a removable memory, or an external memory device used as a backup device.

The library database 203 stores the collection of media files stored in the data storage component 202. The data storage component 202 has at least one file folder. The file folder may be named similarly to the storage path of the media file stored in the high-capacity storage component 102 of the computer system 100, and the corresponding media files are stored in the respective folders. In addition, the library database 203 stores data for library search and folder search of the collection of media files. The library database 203 supports both the library search function and the folder search function.

The A/V data converter 204 includes an audio codec and a video codec, and encodes or decodes the input/output media data. The playback device 205 is an audio and video playback device, and may include a speaker and a display device.

The user interface 206 includes one or more of a touch pad, a remote controller, and a key input unit. The user interface 206 controls the powering up and down of the portable device 200, a playback control of the media files, and media file selection and management. The controller 209 controls and integrates the operations of the components and devices within the portable device.

If the portable device 200 is operatively connected to the system 100 through the interfaces 101 and 201, the computer system 100 first recognizes the operative connection of the portable device 200. The user may then initiate an application for controlling the portable device 200 before, while or after the connection through the network interfaces is made. Access of the media files by the portable device 200 can be controlled or implemented by the controller 110 and an application program stored in the high-capacity storage component 102.

The user selects the media files stored in the high-capacity storage 102 with the user interface 106. The user may search and select the file or files to be copied to the portable device. The media storage path extraction component 103 extracts the storage path of the selected media file and transfers the extracted media storage path to the controller 110. The controller 110 creates the storage path (or storage directory) with the same name in the data storage component 202 of the portable device 200. The computer system 100 executes the master synchronizing function and creates the same directory as the extracted media storage directory in the portable device 200 which executes a slave function. Accordingly, the media storage path includes at least one hierarchal folder directory according to the master-slave relationship of the system 100 and the portable device 200.

For example, if the media storage path of the computer system 100 is C:\aaa\bbb\ccc, the media storage directory created in the data storage component 202 of the portable device 200 is \C\aaa\bbb\ccc. The media storage path includes a disk drive path of the computer system 100 and at least one hierarchal folder directory. Also, the folder directory can be created by one or more upper hierarchal directories in reverse location that remotely creates the directory and that is in a different location from where the actual media file is stored. For example, the media storage directory can be \bbb\ccc. The user can select the number of the hierarchal folders as an option to the extent that the user can recognize the hierarchal folders.

Since the media storage path is stored using the same folder name, the media storage path is easily retrieved and searched. The hierarchal configuration overcomes difficulties generally associated with media file name changes that may occur if the media file is simply stored with reference to the local library. Also, the portable device receives information on the storage path of the media file and creates the storage path based on the media storage path stored in the computer system. When the folder corresponding to the media storage path is created in the portable device 200, the controller 110 of the computer system 100 copies and stores the corresponding media file in the folder.

For example, referring to FIG. 2, the folder and the associated media file in the high-capacity storage component 102 of the computer system 100 are copied and stored as the folder and associated media file in the data storage component 202 of the portable device 200. The computer system 100 establishes the library corresponding to the selected media file and stores the established library in the library database 230 of the portable device 200.

The media file selected in the computer system 100, the storage library of the media file, and, if necessary, the library, are created and transmitted to the portable device 200. Therefore, using an interface having a similar structure to Windows explorer, the media file stored in the data storage component 202 can be searched through the user interface 206 (e.g., through a touch pad on the portable device 200). The portable device 200 can find the stored media files through a folder search according to file type, name or other file characteristic (such as date, size or location).

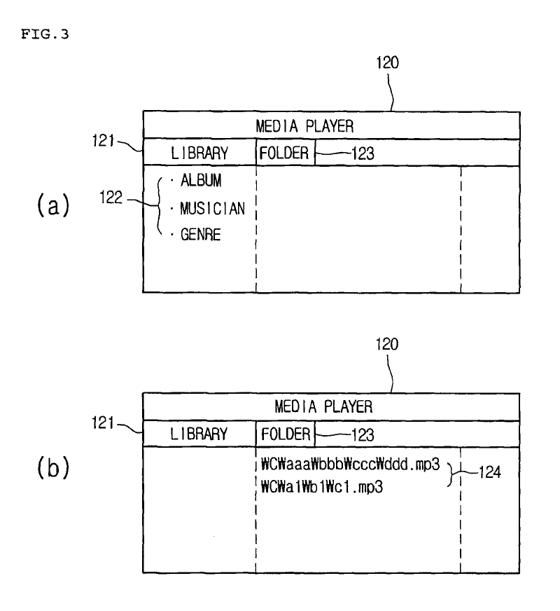

Referring to FIGS. 3A and 3B, the media files can be found through a library search or a folder search on a media player. When the library search 121 is selected as illustrated in FIG. 3A, a library item 122 can be provided to the user. When the folder search 123 is selected as illustrated in FIG. 3B, the folder search path 124 can be provided to the user. If the media player is run in the portable device 200, the library item or folder search item is provided. The user can classify and select the media files or libraries, such as according to genre, album, or artist, using a search list.

If the media storage paths on the computer system 100 are transmitted to the portable device 200, the media paths may be created by a media path creator (not shown) in the portable device 200. The media files are then transferred to the created media path and stored.

In addition, the media storage path extraction component 103 of the computer system 100 extracts the path of the media files stored in a disk of an accessible disk recording and playback device, such as CD, DVD, or Blue laser Disk (BD). By copying the extracted path and media files, and transferring the files to the external, portable device, the same directory and media file can be created in the portable device 200.

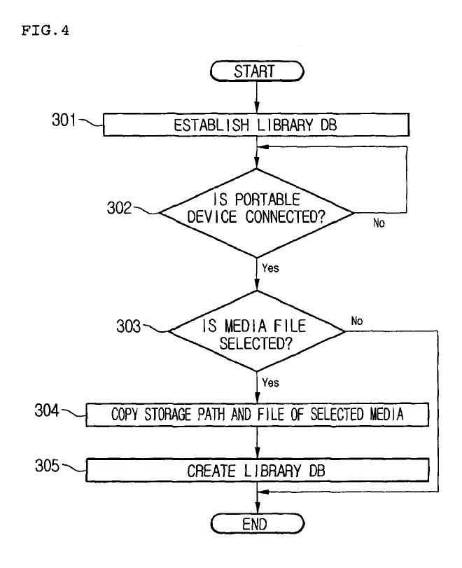

Referring to FIG. 4, in processing files using libraries, the library database of the media files stored in the computer system is established (301). The system 100 then determines if the portable device 200 is connected to the computer system 100 (302). If the portable device 200 is connected, the system 200 determines if a media file has been selected by the user for transmitting to the portable device (303). An application for controlling the portable device is executed and a search tool initiated by the application provides file deletion/upload/download and file name change capability to the user. If a media file is selected, the storage directory of the selected media file is created or copied with the same folder name in the data storage component of the portable device (304). The selected media file is stored in the corresponding folder of the system 100 and the library database is generated in the system 100 (305).

In addition, a library function is provided together with the copy of the media file. The library database is established, such that the library function corresponding to the selected media file can be used, and the library database is created in the portable device 200 and the system 100. The library database can be created in the portable device 200 while the portable device 200 is playing the media file.

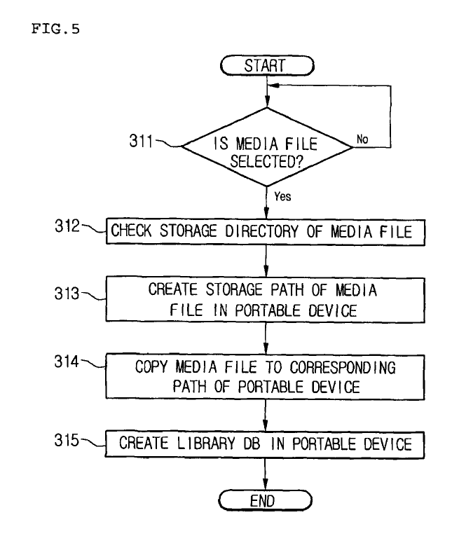

Referring to FIG. 5, if a media file is selected (311), the storage path of the selected media file is determined and extracted (312). The extracted media file is created with a similar name to the same folder in the portable device 200 (313). The extracted media file is created with the same structure as at least one folder in the data storage component of the portable device 200.

The selected media file then is copied to the respectively created folders of the portable device 200 (314). The portable device 200 may then be disconnected from the computer system. When the media player is run on the portable device 200, the library database supporting both the folder search and the library search is created and provided to the user (315).

The library database supporting both the folder search and the library search can be implemented on the computer system 100 or the media player of the portable device 200. In addition, the folder search function and the library search function can be provided to the library database created in the portable device 200 to selectively use the media storage path and library function.

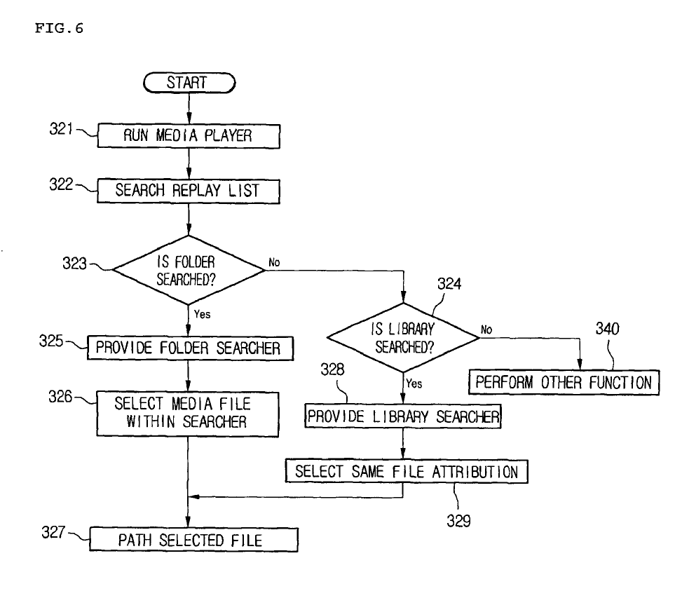

Referring to FIG. 6, the media player is run in the portable device (321) and the replay list is searched (322). Thereafter, a folder search (323) or a library search (324) can be selected for the replay list search. If the folder search is selected (323), the folder searcher is provided (325). The media files can be selected within the folder searcher (326), and the selected media file is played (327).

If the library search is selected (324), the library is searched for a desired media file (328). If the user selects a file having the target file attribute, such as genre, album, artist or other file characteristic, the selected file is played in the media player (327). If the folder searcher supports the folder browsing function, the media files can be selected after executing the folder searcher without running the media player.

Alternatively, if the selected function is neither the folder search function nor the library search function, another folder or library related function is executed (340).

Accordingly, the same user interface and library structure can be provided for the computer system and a portable device to synchronize media files across both client devices. In addition to the library structure for the media files, the folder search function is provided such that the media files can be searched more conveniently across both client devices. Accordingly, the user of the portable device 200 or system 100 can access media files across or in either device conveniently and with a seamless interface accessible by the user.

Other features will be apparent from the following description, including the drawings, and the claims.

What is claimed is:

1. A method for synchronizing media in a computer system with an external computing device, comprising:
detecting an operative connection between the external computing device and the computer system;
selecting a media file in the computer system to be transmitted to the external computing device;
checking a storage path of the selected media file;
generating a parallel storage path in the external computing device;
copying the selected media file; and
transmitting the copied media file to the parallel storage path of the external computing device.

2. The method according to claim 1, further comprising:
establishing a library of media files; and
transmitting the library containing at least the selected media file to the external computing device.

3. The method according to claim 1, wherein the parallel storage path in the external computing device includes at least one hierarchal file folder.

4. The method according to claim 1, wherein the external computing device provides the storage path of the media file.

5. The method according to claim 1, wherein the media storage path in the external computing device is a folder search path.

6. The method according to claim 1, further comprising providing a hierarchal folder search and a library search option for the selected media file of the external device.

7. The method according to claim 1, wherein transmitting the selected media file to the parallel storage path of the external computing device comprises creating at least one hierarchal folder corresponding to the media storage path.

8. The method according to claim 1, wherein the media file includes one or more of a still image file, a moving image file, or an audio file.

9. The method according to claim 1, wherein the external computing devices is a portable media player.

10. A method for synchronizing media in a computer system with a portable media playback device, comprising:
operatively connecting the portable media playback device to the computer system;
searching a library of media files within the computer system;
selecting a media file in the computer system for playback or storage on the portable media playback device;
identifying a storage path of the selected media file within the computer system;
generating a parallel storage path in the portable media playback device, wherein the parallel storage path is similar to a storage path of the selected media file within the computer system; and
transmitting the selected media file to the parallel storage path of the portable media playback device, wherein the file name of the selected media file and parallel storage path include common characteristics capable of being indexed and searched across both the portable media playback device and the computer system.

12. A media synchronization apparatus for a computer system, comprising:
a network interface configured to operatively connect to an external device and to transfer media files between the computer system and the external device;
a media storage directory extraction component configured to recognize if the external device is operatively connected to the computer system and to extract a storage path of a selected media file from the computer system; and
a controller configured to copy and to transmit the extracted storage path of the selected media file to the external device through the network interface, wherein the controller is configured to transmit the extracted storage path and the selected media file to the external device.

13. The apparatus according to claim 12, further comprising a data storage device configured to generate a library of indexed and searchable media files within the computer system.

14. The apparatus according to claim 12, wherein the media storage directory extraction component is configured to extract at least one hierarchal folder path stored in the computer system.

15. The apparatus according to claim 12, wherein the controller is configured to generate a parallel storage path of the media file in the external device substantially similar to the storage path in the computer system.

16. The apparatus according to claim 12, wherein the external device is a portable media playback device.

17. The apparatus according to claim 16, wherein the portable media playback device is one or more of a personal digital assistant (PDA), a portable media player (PMP), or a MP3 player.

18. The apparatus according to claim 15, wherein the parallel storage path generated in the external device is provided in a search folder directory.

19. The apparatus according to claim 12, further comprising a user interface for selecting one or more media files to be transmitted to the external device.

20. A system for synchronizing media between a portable media playback device and a host computer, the system comprising a media file manager within the host computer, the media file manager including: a network interface configured to operatively connect to the portable media playback device and to transfer media files between the host computer and the portable media playback device; a media storage directory extraction component configured to recognize if the portable media playback device is operatively connected to the host computer and to extract a storage path of a selected media file from the host system; and a controller configured to copy and to transmit the extracted storage path of the selected media file to the portable media playback device through the network interface, wherein the controller is configured to transmit the extracted storage path and the selected media file to the portable media playback device.

21. The system according to claim 20, further comprising the portable media playback device.

22. The system according to claim 21, wherein the portable media playback device comprises:
a data storage device configured to store one or more media files in a master-slave association with media files stored within the host computer;
a controller configured to control a media player for playing or recording a selected media file; and
a network interface configured to operatively connect the portable media playback device to the host computer and to transfer media files to and from the host computer.

23. The system according to claim 22, wherein the portable media playback device comprises a user interface configured to enable a user to search media files stored within the data storage device of the portable media playback device or the host computer.
